(19) United States
(12) Patent Application Publication
(10) Pub. No.: US 2022/0222963 A1
(43) Pub. Date: Jul. 14, 2022

(54) LEARNING DEVICE, LEARNING METHOD, AND LEARNING PROGRAM

(71) Applicant: NTT Communications Corporation, Tokyo (JP)

(72) Inventors: Ryosuke TANNO, Tokyo (JP); Syuhei ASANO, Funabashi-shi (JP)

(73) Assignee: NTT Communications Corporation, Tokyo (JP)

(21) Appl. No.: 17/711,030

(22) Filed: Apr. 1, 2022

Related U.S. Application Data
(63) Continuation of application No. PCT/JP2020/037636, filed on Oct. 2, 2020.

(30) Foreign Application Priority Data
Oct. 4, 2019 (JP) 2019-183964

(51) Int. Cl. G06V 40/10; G06V 10/764; G06V 10/26; G06V 10/776; G06V 10/82; G06N 20/00

(52) U.S. Cl. CPC G06V 40/103; G06V 10/764; G06N 20/00; G06V 10/776; G06V 10/82; G06V 10/267

(57) ABSTRACT

A learning device estimates skeleton data by using the acquired image data as an input, and using a skeleton estimation model for estimating the skeleton data related to a skeleton of the person. The learning device also uses the acquired image data as an input, and divides a region of the image data per classification of the clothing by using a clothing form region division model for dividing regions of respective pieces of the clothing of the person included in the image data per classification of the clothing. Subsequently, the learning device uses an estimation result and a division result as inputs, estimates the skeleton data by using an improved skeleton estimation model, and outputs a discrimination result of the skeleton input to a discrimination model by using the discrimination model that is learned to discriminate the estimated skeleton data from skeleton data as a correct answer.

### CROSS-REFERENCE TO RELATED APPLICATIONS

This application is a continuation of PCT International Application No. PCT/JP2020/037636 filed on Oct. 2, 2020 which claims the benefit of priority from Japanese Patent Application No. 2019-183964 filed on Oct. 4, 2019, the entire contents of each are incorporated herein by reference.

### FIELD

The present invention relates to a learning device, a learning method, and a learning program.

### BACKGROUND

In recent years, there is known a technique of performing personal authentication using various kinds of biometric authentication. As such an authentication technique, for example, there is known a technique of performing skeleton estimation for estimating position coordinates of a skeleton from image data including the whole body of a person as an authentication target, and performing personal authentication based on an estimation result. The related technologies are described, for example, in: Japanese Patent Application Laid-open No. 2018-013999.

However, a conventional method of skeleton estimation has the problem that skeleton estimation cannot be performed with high accuracy in some cases. For example, the conventional method of skeleton estimation has the problem that accuracy of skeleton estimation is lowered in a case in which a person as an authentication target in image data wears clothing with which a body line of the person himself/herself cannot be clearly recognized.

### SUMMARY

It is an object of the present invention to at least partially solve the problems in the conventional technology.

According to an aspect of the embodiments, a learning device includes: processing circuitry configured to: acquire image data including a person; first estimate skeleton data by using the image data acquired as an input, and using a skeleton estimation model for estimating the skeleton data related to a skeleton of the person; divide a region of the image data per classification of clothing by using the image data acquired as an input, and using a division model for dividing regions of respective pieces of the clothing of the person included in the image data per classification of the clothing; second estimate the skeleton data by using an estimation result obtained and a division result obtained as inputs, and using an improved skeleton estimation model for estimating the skeleton data; output a discrimination result of the skeleton input to a discrimination model by using the discrimination model that is learned to discriminate the skeleton data estimated from skeleton data as a correct answer; and optimize the improved skeleton estimation model and the discrimination model based on the discrimination result output.

The above and other objects, features, advantages and technical and industrial significance of this invention will be better understood by reading the following detailed description of presently preferred embodiments of the invention, when considered in connection with the accompanying drawings.

### BRIEF DESCRIPTION OF DRAWINGS

FIG. 1 is a block diagram illustrating a configuration example of a learning device according to a first embodiment;

FIG. 2 is a diagram for explaining an example of skeleton data;

FIG. 3 is a diagram for explaining an example of a learning method for an adversarial network;

FIG. 4 is a diagram for explaining an example of the learning method for the adversarial network;

FIG. 5 is a flowchart illustrating an example of a procedure of processing performed by the learning device according to the first embodiment; and

FIG. 6 is a diagram illustrating a computer that executes a learning program.

### DESCRIPTION OF EMBODIMENT(S)

The following describes embodiments of a learning device, a learning method, and a learning program according to the present application in detail based on the drawings. The learning device, the learning method, and the learning program according to the present application are not limited to the embodiments.

### First Embodiment

The following embodiment describes a configuration of a learning device according to a first embodiment and a procedure of processing performed by a learning device 10 in order, and lastly describes an effect of the first embodiment.

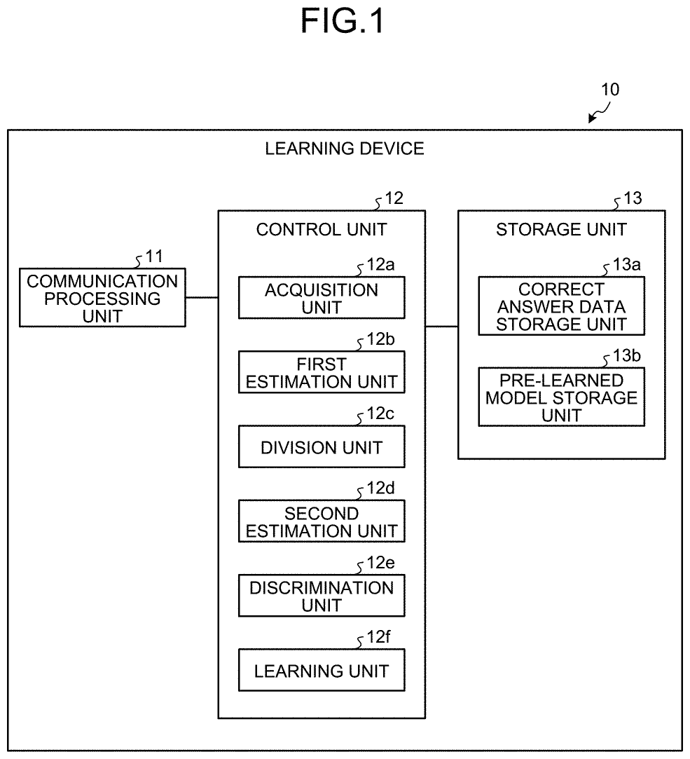

Configuration of learning device First, the following describes the configuration of the learning device 10 with reference to FIG. 1. FIG. 1 is a block diagram illustrating a configuration example of the learning device according to the first embodiment. For example, the learning device 10 learns a model for performing skeleton estimation. The model for performing skeleton estimation learned by the learning device 10 is assumed to be applied to an authentication processing system that performs personal authentication, for example.

In learning processing, for example, the learning device 10 performs learning by using a Generative Adversarial Network (GAN) that is a generative adversarial network as a type of neural network, and combining two neural networks including what is called a generator and a discriminator. In the learning device 10 according to the first embodiment, an improved skeleton estimation model corresponds to the generator, and a discrimination model corresponds to the discriminator. For example, as the learning processing in the generative adversarial network, the generator is constructed to generate fake data (estimated skeleton data), and the discriminator is constructed to discriminate whether input data is skeleton data as a correct answer or fake data generated by the generator.

As illustrated in FIG. 1, the learning device 10 includes a communication processing unit 11, a control unit 12, and a storage unit 13. The following describes processing performed by each unit included in the learning device 10.

The communication processing unit 11 controls communication related to various kinds of information exchanged with a connected device. For example, the communication processing unit 11 receives, from an external device, image data as a processing target of skeleton estimation. The storage unit 13 stores data and computer programs necessary for various kinds of processing performed by the control unit 12 and includes a correct answer data storage unit 13a and a pre-learned model storage unit 13b. For example, the storage unit 13 is a storage device such as a semiconductor memory element including a random access memory (RAM), a flash memory, and the like.

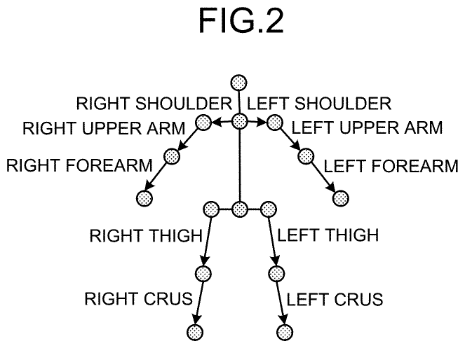

The correct answer data storage unit 13a stores, as correct answer data input to the discrimination model described later, image data including a person and skeleton data of the person in association with each other. The following describes an example of the skeleton data using the example of FIG. 2. FIG. 2 is a diagram for explaining the example of the skeleton data. As exemplified in FIG. 2, the skeleton data stored in the correct answer data storage unit 13a is represented by points indicating respective parts, and lines or arrows connecting adjacent points. In the example of FIG. 2, predetermined points and arrows starting from the respective predetermined points in the skeleton data are portions corresponding to articulations, and the skeleton data includes portions of a “right shoulder”, a “right upper arm”, a “right forearm”, a “left shoulder”, a “left upper arm”, a “left forearm”, a “right thigh”, a “right crus”, a “left thigh”, and a “left crus”.

The pre-learned model storage unit 13b stores a pre-learned model learned by a learning unit 12f described later. For example, the pre-learned model storage unit 13b stores, as pre-learned models, a skeleton estimation model for performing skeleton estimation, and a clothing form region division model for dividing a form region of clothing in the image. The pre-learned model storage unit 13b may store one pre-learned model obtained by integrating the skeleton estimation model with the clothing form region division model.

The control unit 12 includes an internal memory for storing required data and computer programs specifying various processing procedures and executes various kinds of processing therewith. For example, the control unit 12 includes an acquisition unit 12a, a first estimation unit 12b, a division unit 12c, a second estimation unit 12d, a discrimination unit 12e, and the learning unit 12f. Herein, the control unit 12 is, for example, an electronic circuit such as a central processing unit (CPU), a micro processing unit (MPU), and a graphical processing unit (GPU), or an integrated circuit such as an application specific integrated circuit (ASIC) and a field programmable gate array (FPGA).

The acquisition unit 12a acquires image data including a person. For example, the acquisition unit 12a acquires image data including the whole body of a person wearing clothing. The acquisition unit 12a may acquire the image data from an external device, or may acquire image data prepared in advance for learning from the inside of the device.

The first estimation unit 12b uses the image data acquired by the acquisition unit 12a as an input, and estimates the skeleton data by using the skeleton estimation model for estimating the skeleton data related to a skeleton of the person. For example, the first estimation unit 12b specifies positions of respective parts of the skeleton of the person, and estimates positions of a “right shoulder”, a “right upper arm”, a “right forearm”, a “left shoulder”, a “left upper arm”, a “left forearm”, a “right thigh”, a “right crus”, a “left thigh”, and a “left crus” as portions corresponding to respective articulations.

The division unit 12c uses the image data acquired by the acquisition unit 12a as an input, and divides a region of the image data per classification of the clothing by using the clothing form region division model for dividing regions of respective pieces of the clothing of the person included in the image data per classification of the clothing. For example, the division unit 12c specifies respective regions of the clothing including an upper garment, trousers, a hat, socks, and the like in the image data, and divides the region of the image data per classification of the clothing.

The second estimation unit 12d uses an estimation result obtained by the first estimation unit 12b and a division result obtained by the division unit 12c as inputs, and estimates the skeleton data using the improved skeleton estimation model for estimating the skeleton data. Specifically, the second estimation unit 12d compares a region division result of the clothing with a result of skeleton estimation to improve the skeleton estimation result. That is, the second estimation unit 12d improves the skeleton estimation result by using the division result obtained by the division unit 12c for compensating for a portion at which skeleton estimation is difficult to be performed by the first estimation unit 12b.

The discrimination unit 12e uses the discrimination model that is learned to discriminate the skeleton data estimated by the second estimation unit 12d from the skeleton data as a correct answer to output a discrimination result of the skeleton input to the discrimination model. For example, the discrimination unit 12e inputs, to the discrimination model, any one of the skeleton data estimated by the second estimation unit 12d and the skeleton data as the correct answer stored in the correct answer data storage unit 13a. Herein, the discrimination model discriminates whether the input skeleton data is skeleton data estimated from the image data or the skeleton data as the correct answer corresponding to the image data.

The learning unit 12f optimizes the improved skeleton estimation model and the discrimination model based on the discrimination result output by the discrimination unit 12e. That is, the learning unit 12f optimizes the discrimination model so that the discrimination model can correctly discriminate whether the input skeleton data is the estimated skeleton data or correct answer data, and optimizes the improved skeleton estimation model so that the skeleton estimation model and the clothing form region division model can generate skeleton data that is assumed to be skeleton data as the correct answer data.

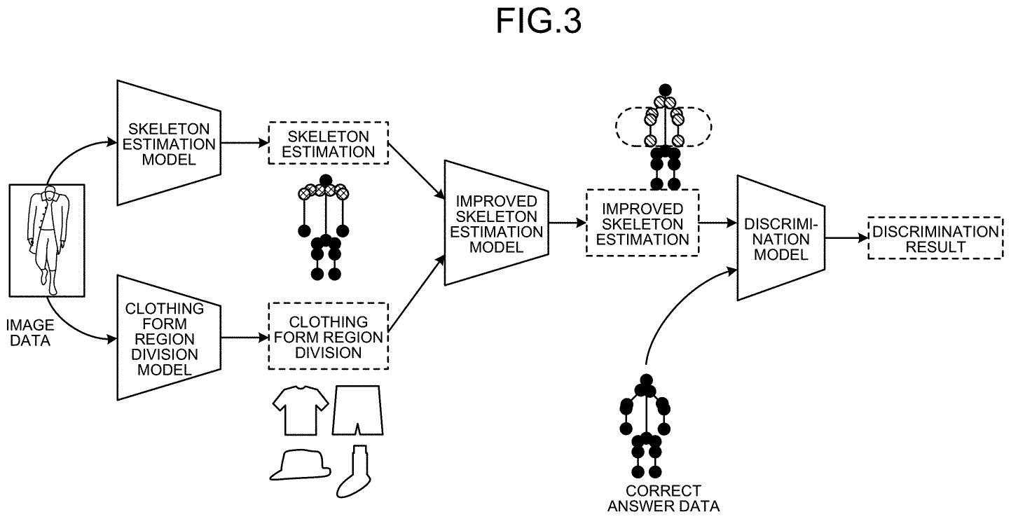

In this way, in the learning processing, the learning device 10 performs learning by using the GAN that is the generative adversarial network as a type of neural network, and combining two neural networks including what is called the generator and the discriminator. The following describes an example of the learning method for the adversarial network with reference to FIG. 3. FIG. 3 is a diagram for explaining an example of the learning method for the adversarial network.

As exemplified in FIG. 3, the learning device 10 inputs the image data to each of the skeleton estimation model and the clothing form region division model. The learning device 10 then uses the image data as input data, and estimates the skeleton using the skeleton estimation model. The learning device 10 also uses the image data as input data, and divides the region of the image data per classification of the clothing by using the clothing form region division model. The learning device 10 then uses the result of skeleton estimation output from the skeleton estimation model and the region division result of the clothing output from the clothing form region division model as input data, and estimates the skeleton by using the improved skeleton estimation model.

The learning device 10 then inputs, to the discrimination model, any one of the estimated skeleton data and the skeleton data as the correct answer stored in the correct answer data storage unit 13a, and outputs, from the discrimination model, a discrimination result obtained by discriminating whether the input skeleton data is the skeleton data estimated from the image data or the skeleton data as the correct answer corresponding to the image data.

For example, the discrimination model discriminates whether the input data is the estimated skeleton data or the skeleton data as the correct answer stored in the correct answer data storage unit 13a, and outputs a probability of correct answer for the input data. For example, the discrimination model is set to output values from “0” to “1”. A value closer to “1” represents a higher probability of correct answer, and a value closer to “0” represents a lower probability of correct answer.

The learning device 10 then optimizes the generator and the discriminator so that the discrimination result of the discrimination model becomes closer to the correct answer. That is, the discrimination model is optimized by learning to be able to output a high value (a value close to 1) in a case in which the skeleton data as the correct answer is input, and to be able to output a low value (a value close to “0”) in a case in which the estimated skeleton data is input. The learning device 10 then optimizes the generator and the discriminator so that the discrimination result of the discrimination model becomes closer to the correct answer. The learning device 10 also optimizes the improved skeleton estimation model to be able to estimate the skeleton data similar to the skeleton data as the correct answer based on the discrimination result.

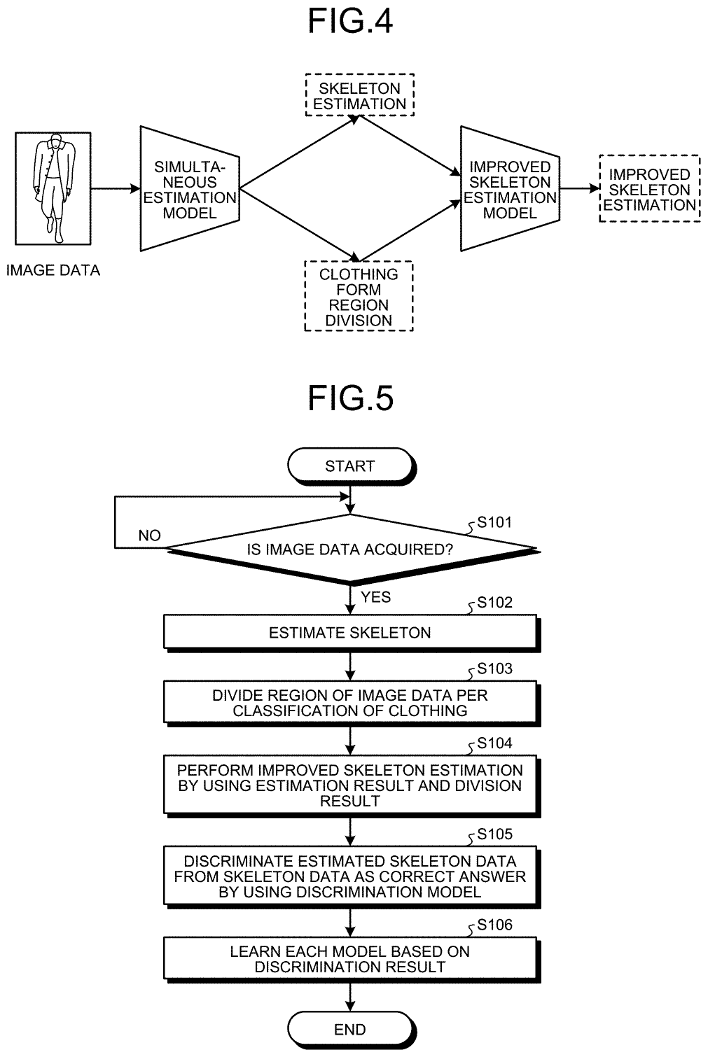

Described is a case in which the skeleton estimation model and the clothing form region division model are different models, but the embodiment is not limited thereto. For example, as exemplified in FIG. 4, the learning device 10 may input the image data to a simultaneous estimation model obtained by integrating the skeleton estimation model with the clothing form region division model, perform processing of estimating the skeleton and processing of dividing the region of the image data per classification of the clothing, use the result of skeleton estimation output from the skeleton estimation model and the region division result of the clothing output from the clothing form region division model as input data, and estimate the skeleton by using the improved skeleton estimation model.

Processing Procedure of Learning Device

Next, the following describes an example of a processing procedure performed by the learning device 10 according to the first embodiment with reference to FIG. 5. FIG. 5 is a flowchart illustrating an example of a procedure of processing performed by the learning device according to the first embodiment.

As exemplified in FIG. 5, in the learning device 10, if the acquisition unit 12a acquires the image data including the whole body of the person wearing the clothing (Yes at Step S101), the first estimation unit 12b uses the image data acquired by the acquisition unit 12a as an input, and estimates the skeleton data by using the skeleton estimation model for estimating the skeleton data related to the skeleton of the person (Step S102).

The division unit 12c then divides the region of the image data per classification of the clothing (Step S103). For example, the division unit 12c specifies respective regions of the clothing including an upper garment, trousers, a hat, socks, and the like in the image data, and divides the region of the image data per classification of the clothing.

Subsequently, the second estimation unit 12d uses the estimation result obtained by the first estimation unit 12b and the division result obtained by the division unit 12c to perform improved skeleton estimation for estimating the skeleton data (Step S104). Specifically, the second estimation unit 12d uses the result of skeleton estimation output from the skeleton estimation model and the region division result of the clothing output from the clothing form region division model as input data, and estimates the skeleton by using the improved skeleton estimation model.

The discrimination unit 12e then discriminate the estimated skeleton data from the skeleton data as the correct answer by using the discrimination model (Step S105). For example, the discrimination unit 12e inputs, to the discrimination model, any one of the skeleton data estimated by the second estimation unit 12d and the skeleton data as the correct answer stored in the correct answer data storage unit 13a.

Thereafter, the learning unit 12f learns the improved skeleton estimation model and the discrimination model based on the discrimination result output by the discrimination unit 12e (Step S106). That is, the learning unit 12f optimizes the discrimination model so that the discrimination model can correctly discriminate whether the input skeleton data is the estimated skeleton data or the correct answer data, and optimizes the improved skeleton estimation model so that the improved skeleton estimation model can generate skeleton data that is assumed to be the skeleton data as the correct answer data.

### Effect of First Embodiment

The learning device 10 according to the first embodiment acquires the image data including the person, and estimates the skeleton data by using the acquired image data as an input, and using the skeleton estimation model for estimating the skeleton data related to the skeleton of the person. The learning device 10 also uses the acquired image data as an input, and divides the region of the image data per classification of the clothing by using the clothing form region division model for dividing regions of respective pieces of the clothing of the person included in the image data per classification of the clothing. Subsequently, the learning device 10 uses the estimation result and the division result as inputs, estimates the skeleton data by using the improved skeleton estimation model, and outputs the discrimination result of the skeleton input to the discrimination model by using the discrimination model that is learned to discriminate the estimated skeleton data from the skeleton data as the correct answer. The learning device 10 then optimizes the improved skeleton estimation model and the discrimination model based on the output discrimination result. Thus, the learning device 10 can generate a model for performing skeleton estimation with high accuracy.

That is, the learning device 10 learns the improved skeleton estimation model and the discrimination model by using the generative adversarial network, and performs skeleton estimation by applying the learned improved skeleton estimation model together with the skeleton estimation model and the clothing form region division model, so that it is possible to perform skeleton estimation by using the form of the clothing.

The learning device 10 learns the improved skeleton estimation model and the discrimination model by using the generative adversarial network, and performs skeleton estimation by applying the learned improved skeleton estimation model together with the skeleton estimation model and the clothing form region division model, so that skeleton estimation that is robust for the form of the clothing is enabled, and it is possible to generate the model for performing skeleton estimation with high accuracy even in a case in which the person wears clothing with which a body line cannot be clearly recognized.

System Configuration and Like

The components of the devices illustrated in the drawings are merely conceptual, and it is not required that they are physically configured as illustrated necessarily. That is, specific forms of distribution and integration of the devices are not limited to those illustrated in the drawings. All or part thereof may be functionally or physically distributed/integrated in arbitrary units depending on various loads or usage states. All or optional part of the processing functions performed by the respective devices may be implemented by a CPU or a GPU and computer programs analyzed and executed by the CPU or the GPU, or may be implemented as hardware using wired logic.

Among pieces of the processing described in the present embodiment, all or part of the pieces of processing described to be automatically performed can be manually performed, or all or part of the pieces of processing described to be manually performed can be automatically performed by using a known method. Additionally, the processing procedures, control procedures, specific names, and information including various kinds of data and parameters described herein or illustrated in the drawings can be optionally changed unless otherwise specifically noted.

Computer Program

It is also possible to create a computer program describing the processing performed by an information processing device described in the above embodiment in a computer-executable language. For example, it is possible to create a computer program describing the processing performed by the learning device 10 according to the embodiment in a computer-executable language. In this case, the same effect as that of the embodiment described above can be obtained when the computer executes the computer program. Furthermore, such a computer program may be recorded in a computer-readable recording medium, and the computer program recorded in the recording medium may be read and executed by the computer to implement the same processing as that in the embodiment described above.

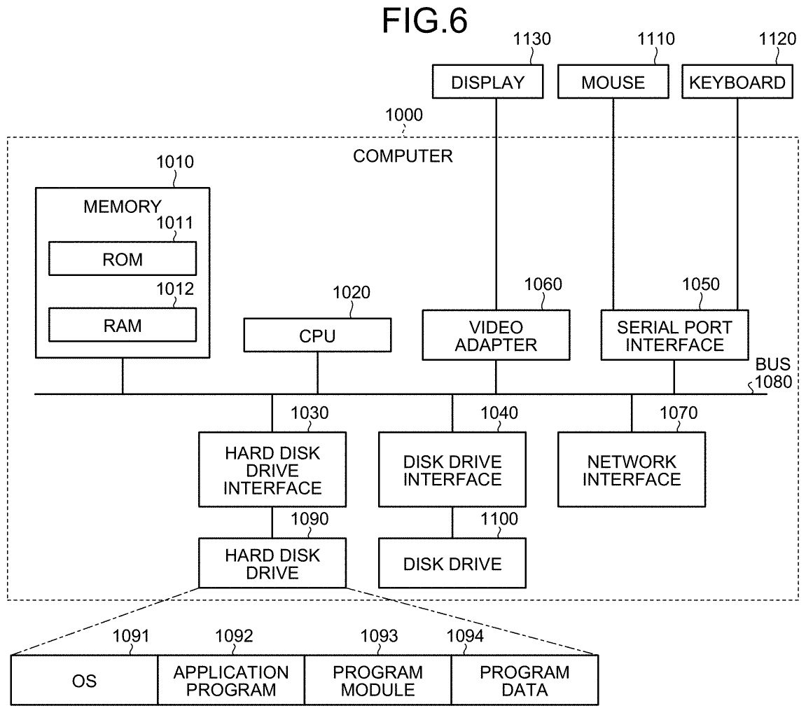

FIG. 6 is a diagram illustrating a computer that executes the learning program. As exemplified in FIG. 6, a computer 1000 includes, for example, a memory 1010, a CPU 1020, a hard disk drive interface 1030, a disk drive interface 1040, a serial port interface 1050, a video adapter 1060, and a network interface 1070, which are connected to each other via a bus 1080.

As exemplified in FIG. 6, the memory 1010 includes a read only memory (ROM) 1011 and a RAM 1012. The ROM 1011 stores, for example, a boot program such as a Basic Input Output System (BIOS). As exemplified in FIG. 6, the hard disk drive interface 1030 is connected to a hard disk drive 1090. As exemplified in FIG. 6, the disk drive interface 1040 is connected to a disk drive 1100. For example, a detachable storage medium such as a magnetic disc or an optical disc is inserted into the disk drive 1100. As exemplified in FIG. 6, the serial port interface 1050 is connected to a mouse 1110 and a keyboard 1120, for example. As exemplified in FIG. 6, the video adapter 1060 is connected to a display 1130, for example.

Herein, as exemplified in FIG. 6, the hard disk drive 1090 stores, for example, an OS 1091, an application program 1092, a program module 1093, and program data 1094. That is, the computer program described above is stored in the hard disk drive 1090, for example, as a program module describing a command executed by the computer 1000.

The various kinds of data described in the above embodiment are stored in the memory 1010 or the hard disk drive 1090, for example, as program data. The CPU 1020 then reads out the program module 1093 or the program data 1094 stored in the memory 1010 or the hard disk drive 1090 into the RAM 1012 as needed, and performs various processing procedures.

The program module 1093 and the program data 1094 related to the computer program are not necessarily stored in the hard disk drive 1090, but may be stored in a detachable storage medium, for example, and may be read out by the CPU 1020 via a disk drive and the like. Alternatively, the program module 1093 and the program data 1094 related to the computer program may be stored in another computer connected via a network (a local area network (LAN), a wide area network (WAN), and the like), and may be read out by the CPU 1020 via the network interface 1070.

According to the present invention, it is possible to generate a model for performing skeleton estimation with high accuracy.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A learning device comprising:
processing circuitry configured to:
acquire image data including a person;
first estimate skeleton data by using the image data acquired as an input, and using a skeleton estimation model for estimating the skeleton data related to a skeleton of the person;
divide a region of the image data per classification of clothing by using the image data acquired as an input, and using a division model for dividing regions of respective pieces of the clothing of the person included in the image data per classification of the clothing;
second estimate the skeleton data by using an estimation result obtained and a division result obtained as inputs, and using an improved skeleton estimation model for estimating the skeleton data;
output a discrimination result of the skeleton input to a discrimination model by using the discrimination model that is learned to discriminate the skeleton data estimated from skeleton data as a correct answer; and
optimize the improved skeleton estimation model and the discrimination model based on the discrimination result output.

2. The learning device according to claim 1, wherein any one of the skeleton data estimated and the skeleton data as the correct answer stored in a storage is input to the discrimination model, and the processing circuitry is further configured to discriminate whether the input skeleton data is the skeleton data estimated or the skeleton data as the correct answer.

3. The learning device according to claim 1, wherein the processing circuitry is further configured to optimize the discrimination model so that the discrimination model is able to correctly discriminate whether the input skeleton data is the estimated skeleton data or correct answer data, and optimize the improved skeleton estimation model so that the skeleton estimation model and the division model are able to generate skeleton data that is assumed to be skeleton data as the correct answer data.

4. A learning method comprising:
acquiring image data including a person;
first estimating skeleton data by using the image data acquired at the acquiring as an input, and using a skeleton estimation model for estimating the skeleton data related to a skeleton of the person;
dividing a region of the image data per classification of clothing by using the image data acquired at the acquiring as an input, and using a division model for dividing regions of respective pieces of the clothing of the person included in the image data per classification of the clothing;
second estimating the skeleton data by using an estimation result obtained at the first estimating and a division result obtained at the dividing as inputs, and using an improved skeleton estimation model for estimating the skeleton data;
discriminating by outputting a discrimination result of the skeleton input to a discrimination model by using the discrimination model that is learned to discriminate the skeleton data estimated at the second estimating from skeleton data as a correct answer; and
learning by optimizing the improved skeleton estimation model and the discrimination model based on the discrimination result output at the discriminating.

5. A non-transitory computer-readable recording medium storing therein a learning program that causes a computer to execute a process comprising:
acquiring image data including a person;
first estimating skeleton data by using the image data acquired at the acquiring as an input, and using a skeleton estimation model for estimating the skeleton data related to a skeleton of the person;
dividing a region of the image data per classification of clothing by using the image data acquired at the acquiring as an input, and using a division model for dividing regions of respective pieces of the clothing of the person included in the image data per classification of the clothing;
second estimating the skeleton data by using an estimation result obtained at the first estimating and a division result obtained at the dividing as inputs, and using an improved skeleton estimation model for estimating the skeleton data;
discriminating by outputting a discrimination result of a skeleton input to the discrimination model by using the discrimination model that is learned to discriminate the skeleton data estimated at the second estimating from skeleton data as a correct answer; and
learning by optimizing the improved skeleton estimation model and the discrimination model based on the discrimination result output at the outputting.
